(19) United States
(12) Patent Application Publication
(10) Pub. No.: US 2010/0066795 A1
(43) Pub. Date: Mar. 18, 2010

(54) INKJET PRINTER

(75) Inventors: Yasunobu Shimamura, Wakayama (JP); Hiroaki Tamura, Wakayama (JP)

Correspondence Address: BLACK LOWE & GRAHAM, PLLC, 701 FIFTH AVENUE, SUITE 4800, SEATTLE, WA, 98104, US

(73) Assignee: NORITSU KOKI CO., LTD., Wakayama (JP)

(21) Appl. No.: 12/561,056

(22) Filed: Sep. 16, 2009

(30) Foreign Application Priority Data
Sep. 18, 2008 (JP) 2008-239612

(51) Int. Cl. B41J 2/01

(52) U.S. Cl. 347/104

(57) ABSTRACT

A media sheet re-supply section is provided which connects the downstream side end to the upstream side end of a feeding section provided at a printing section to form an orbiting feed path together with the feeding section, and which flips over a media sheet sent out from the downstream side end of the feeding section, of which one side has received printing, and supplies it to the upstream side end of the feeding section. The media sheet re-supply section has a length of a feed path capable of holding, during printing on a current media sheet by the printing section, at least one preceding media sheet printed prior to the current media sheet.

### CROSS REFERENCE TO RELATED APPLICATIONS

This application claims priority to Japanese Patent Application No. 2008-239612 filed on Sep. 18, 2008, the disclosure of which including the specification, the drawings, and the claims is hereby incorporated by reference in its entirety.

### BACKGROUND

The present disclosure relates to inkjet printers for printing on both sides of media sheets.

Conventionally, inkjet printers for printing on both side of media sheets have been known. The inkjet printers of this type have two types of configurations. In the first configuration, print heads are disposed on respective sides of a media sheet feed path, and the print heads print on both sides of a media sheet simultaneously or with a short time period staggered (see Japanese Unexamined Patent Application Publication Nos. 07-276716 and 2003-165203, for example). In the second configuration, a print head is disposed on only one side of a media sheet feed path to print on both sides of a media sheet in such a manner that, after printing on one side of the media sheet, the media sheet is flipped over and supplied again to a printing section, thereby allowing the other side of the media sheet to receive printing (see Japanese Unexamined Patent Application Publication No. 2006-192838, for example).

### SUMMARY

However, in the first configuration, although printing capacity can be increased, a large amount of ink adheres in total to both sides, because ink adheres to one side of the paper before ink adhering to the other side is dried. For this reason, strike through caused by ink penetration may be caused, and the media sheet may be curled or waved. Curling and waving may cause disadvantageous feed to cause the printed surfaces to tend to be damaged. As a consequence, in combination with strike through, printing quality of the media sheet may be lowered.

By contrast, in the second configuration, flipping over a media sheet lengthens the time required for printing on both sides of a media sheet, thereby reducing the printing capacity when compared with that of the first configuration. Further, quick flipping over of a media sheet before ink adhering to one side is completely dried may influence adversely on printing quality, and therefore is difficult. Still, quick flipping over may result in printing on one side in a state where the ink adhering to the other side is dried insufficiently. This can increase possibility of degrading printing quality of a media sheet, similarly to the case of the first configuration.

The present invention has been made in view of the foregoing, and its objective is to increase printing capacity as much far as possible, while preventing degradation of printing quality caused due to adhesion of a large amount of ink to a media sheet.

In order to attain the above objective, an inkjet printer having the following configuration is provided. That is, an inkjet printer includes a printing section which prints on one side of a media sheet by ejecting ink from a print head, a media sheet supply section which supplies the media sheet to the printing section, and a feeding section which is provided at the printing section, and which feeds the media sheet supplied from the media sheet supply section to a side opposite to a side of the media sheet supply section when the media sheet is being printed, where the media sheet one of sides of which has received printing in the printing section is flipped over and is supplied again to the printing section, and the printing section prints on another side of the media sheet, thereby printing both sides of the media sheet. The inkjet printer includes: a media sheet re-supply section which connects a downstream side end to an upstream side end of the feeding section to form an orbiting feed path together with the feeding section, and which flips over the media sheet sent out from the downstream side end of the feeding section, of which the one side has received printing, and supplies it to the upstream side end of the feeding section, wherein the media sheet re-supply section includes a U-turn section which causes the media sheet sent out from the downstream side end of the feeding section to make a U-turn so as to flip over the media sheet and change a feed direction of the media sheet to a reverse direction, a reverse feeding section which feeds the media sheet sent out from the U-turn section to a side of the media sheet supply section over the printing section, and a switchback section which switches back the media sheet fed from the reverse feeding section, and supplies it from its rear end to the upstream side end of the feeding section. Further, the media sheet re-supply section has a length of a feed path capable of holding, during printing on one media sheet by the printing section, at least one media sheet printed prior to the media sheet.

By the above configuration, the media sheet sent out from the downstream side end of the feeding section and having one side which has receives printing makes a U-turn in the U-turn section. This flips over the media sheet and reverses the feed direction of the media sheet. Subsequently, the reverse feeding section feeds the media sheet in the direction reverse to that in the feeding section with this state maintained to return it to the side of the media sheet supply section over the printing section. Then, the switchback section switches back the media sheet to supply it from its rear end side toward the upstream side end of the feeding section. The other side of the media sheet supplied to the feeding section is opposed to the print head, and then, the print head ejects ink to the other side for printing. Thus, the both sides of the media sheet are printed.

The media sheet re-supply section is set to have a length of a feed path capable of holding, during printing on a current media sheet by the printing section, at least one preceding media sheet printed prior to the current media sheet. Accordingly, the period between the time when one side of one media sheet is printed and the time when the other side thereof is printed can be utilized for printing at least one successive media sheet. Therefore, although a processing time for duplex printing on only one media sheet increases, printing capacity can be increased in duplex printing on a predetermined number or more of media sheets for business purpose or the like, because the media sheet re-supply section can feed at least one media sheet, while at the same time the printing section can print on another media sheet. Further, ink adhering to one side of a media sheet held by the media sheet re-supply section can be dried sufficiently in printing a successive media sheet until the other side is printed. Printing on the other side in this dried state can prevent degradation of the printing quality of the media sheet. Thus, degradation of the printing quality of the media sheet caused due to adhesion of a large amount of ink can be prevented. Further, printing capacity can be increased especially in duplex printing on a predetermined number or more of media sheets for business purpose.

In the above inkjet printer, the switchback section preferably includes a correction mechanism which corrects a position in a width direction of the media sheet supplied to the upstream side end of the feeding section.

Because the length of the feed path of the media sheet re-supply section is somewhat long to allow the media sheet to tend to be displaced from a standard position in the width direction of the feed path due to flipping over of the media sheer. This makes it difficult to maintain the position in the width direction of the media sheet relative to the feed path with high accuracy. However, in the present example, the correction mechanism is provided in the switchback section. Accordingly, the position in the width direction of the media sheet can be corrected immediately before the media sheet is supplied to the upstream side end of the feeding section. As a consequence, the media sheet can be supplied to the feeding section (printing section) with the media sheet aligned with the standard position in the width direction of the feed path, thereby achieving stable printing on the media sheet at an appropriate position.

In the above inkjet printer, preferably, a feed rate of the media sheet is variable in the U-turn section and the reverse feeding section.

This can set the media sheet feed rate in the U-turn section and the reverse feeding section at an appropriate feed rate according to the dryness of the ink adhering to the one side of the media sheet, which varies according to the environmental conditions (temperature, humidity, etc.) where the inkjet printer is installed, the number of media sheets held in the media sheet re-supply section, and the like.

In the above inkjet printer, it is preferable that the U-turn section and the reverse feeding section include feed roller pairs for sandwiching and feeding the media sheet, and that, of the feed roller pairs, rollers coming into contact with the one side of the media sheet, which has received printing, are made of a material softer than rollers coming into contact with the other side thereof.

The soft rollers that come into contact with one side of the media sheet having received printing can increase acceptable speed of the media sheet feed rate. On the other hand, the hard rollers that come into contact with the other side can ensure accuracy of media sheet feed, thereby reducing meandering and the like. Further, in the case where a part of the media sheet re-supply section is utilized for discharging the media sheet whose both sides have received printing, the hard rollers come into contact with the firstly printed side of the media sheet whose both sides have received printing. However, since the ink adhering to the side is dried sufficiently and stable, the feed rate can be set at the same speed as that at feed after the first printing with no problem caused.

### BRIEF DESCRIPTION OF THE DRAWINGS

FIG. 1 is a perspective view showing an external appearance of an inkjet printer according to an example embodiment.

FIG. 2 is a schematic view of an internal configuration of the inkjet printer when viewed from the side.

FIG. 3 is a cross-sectional view specifically showing the inside of a cassette.

FIG. 4 is a side view specifically showing a printing section and a U-turn section.

FIG. 5 is a plan view specifically showing the printing section.

FIG. 6 is a schematic view showing a state where a switchback roller pair of a switchback section receives a media sheet fed from a reverse feeding section.

FIG. 7 is an illustration corresponding to FIG. 6, which shows a state where a driven roller of the switchback roller pair is switched to a second position.

FIG. 8 is an illustration corresponding to FIG. 6, which shows a state where the switchback roller pair switches back a media sheet to a supply roller pair.

FIG. 9 is an illustration corresponding to FIG. 6, which shows a state where a media sheet is manually fed and inserted through a manual paper feed/insertion opening.

FIG. 10 is a perspective view specifically showing the switchback section.

FIG. 11 is an illustration when viewed in the direction of an arrow C in FIG. 10.

FIG. 12 is an illustration corresponding to FIG. 11, which shows a state where driven rollers of the switchback roller pair and the supply roller pair are in a press-fit released state.

FIG. 13 is an illustration corresponding to FIG. 2, which shows a state where a duplex printing unit is detached from a printer main body.

### DETAILED DESCRIPTION

Example embodiments of the present invention will be described below with reference to the accompanying drawings. The following example embodiments merely describes preferred examples, and are not intended to limit the scopes of the present invention, its applicable objects, and its use.

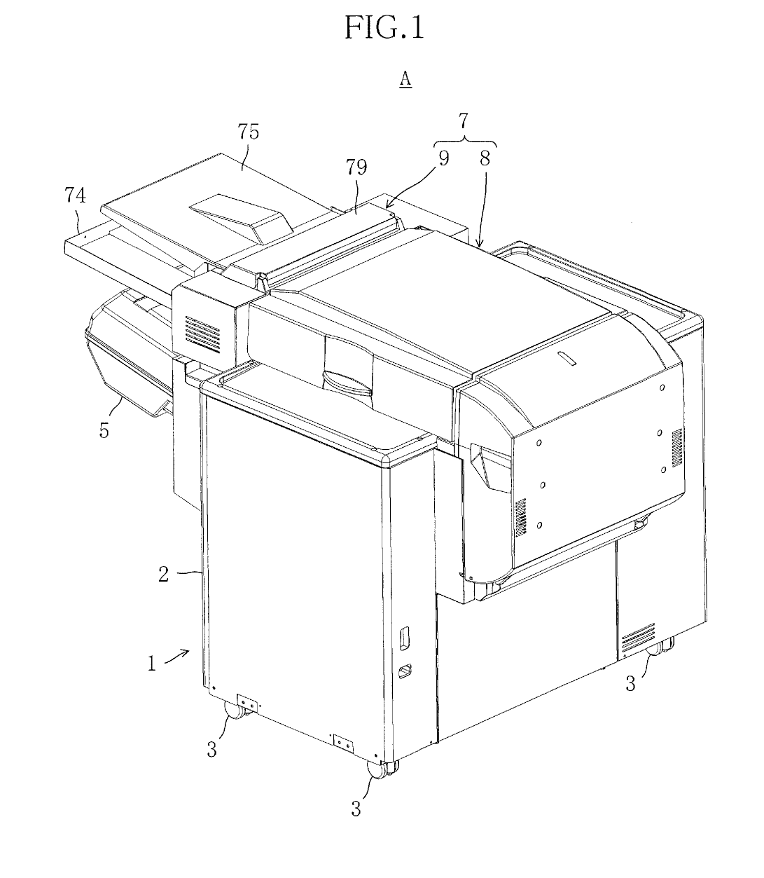

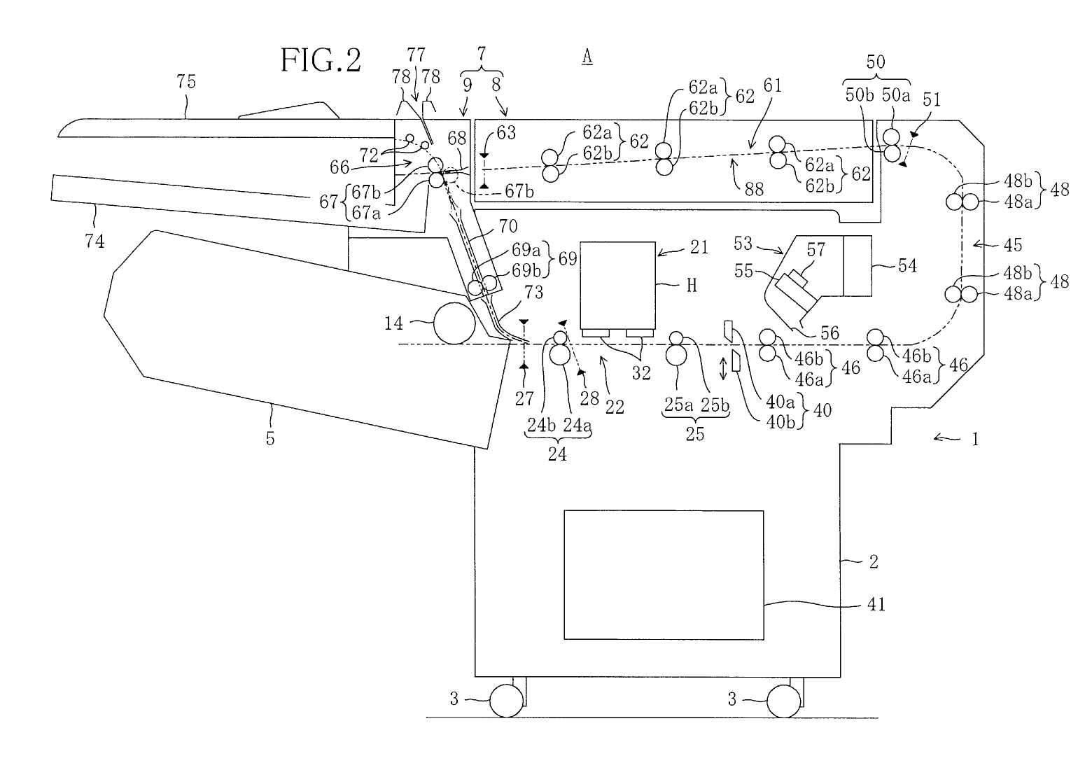

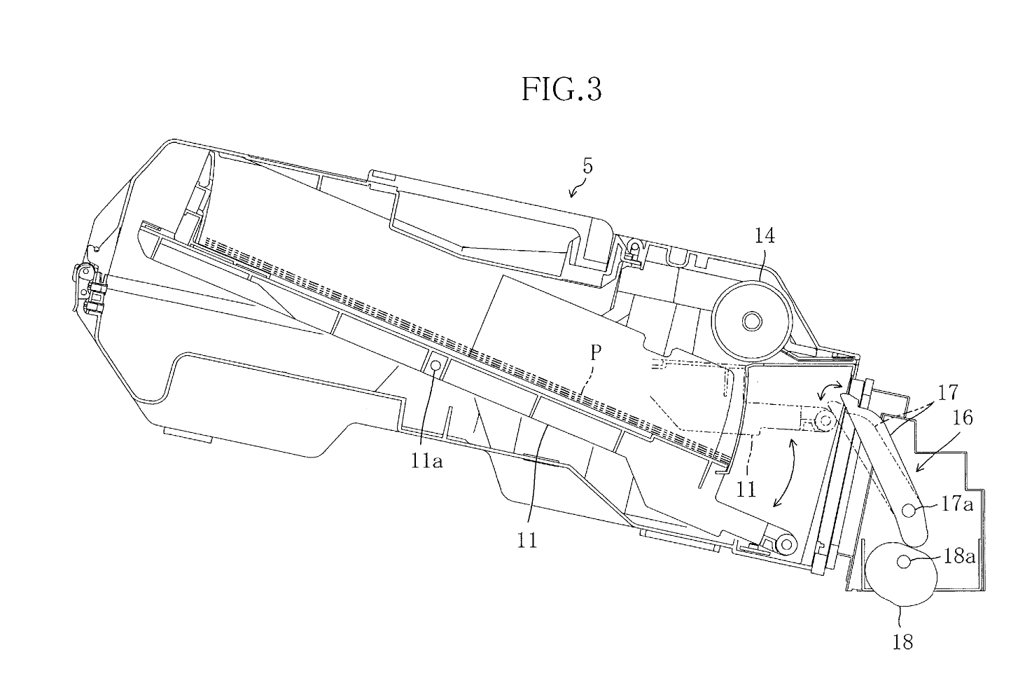

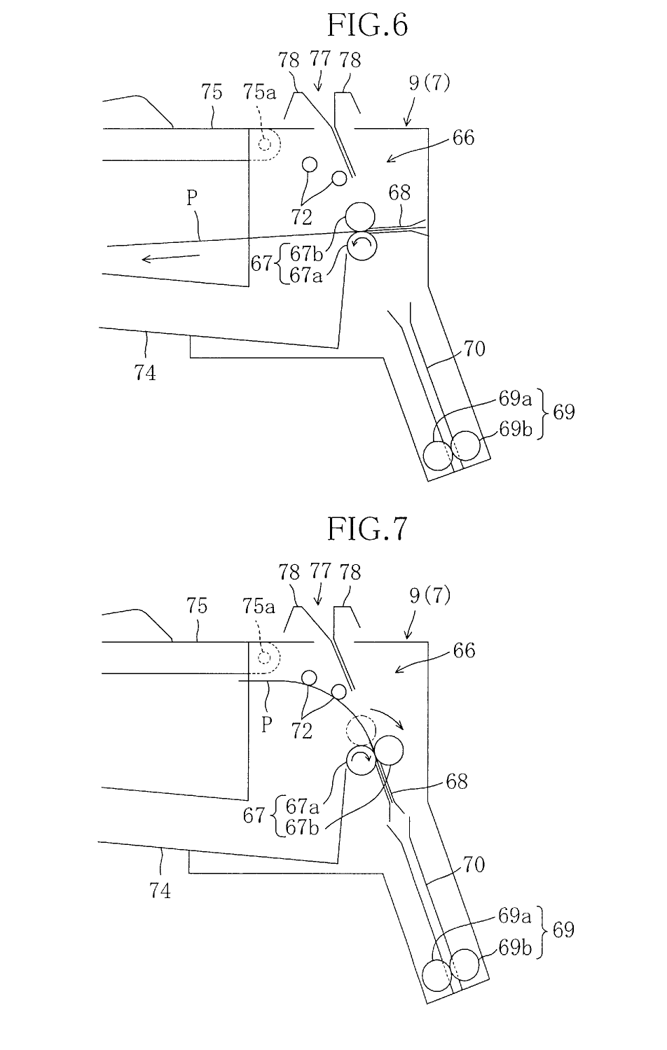

FIG. 1 shows an external appearance of an inkjet printer A according to an example embodiment. FIG. 2 schematically shows an inside configuration of the inkjet printer A. The inkjet printer A is used for a photographic printing system and, for example, prints on a media sheet P (see FIG. 3, FIG. 6, etc., for example) on the basis of image data transmitted via a communication cable from a reception block that obtains the image data and performs necessary correction. The media sheet P is a cut sheet cut to have a predetermined size. A plurality of sizes can be set in advance as this size (the lengths and widths of the media sheets P are determined according to the sizes of the media sheets).

The inkjet printer A includes a printer main body 1, a cassette 5, and a duplex printing unit 7. The printer main body 1 includes a housing 2 having a lower surface provided with a plurality of wheels 3. The cassette 5 is detachably attached to the upper part of one side of the housing 2 of the printer main body 1, and is capable of housing a plurality of media sheets P stacked in their thickness direction. The duplex printing unit 7 is detachably attached to the upper surface of the housing 2. It is noted that, in the present example embodiment, the side where the cassette 5 is attached (left in FIG. 2) is referred to as a printer front side, and the side opposite thereto (right in FIG. 2) is referred to as a printer rear side. Further, the direction perpendicular to the sheet in FIG. 2 is referred to as a printer transverse direction, and agrees with the transverse direction of media sheets P housed in the cassette 5 and fed in the printer main body 5 and the duplex printing unit 7.

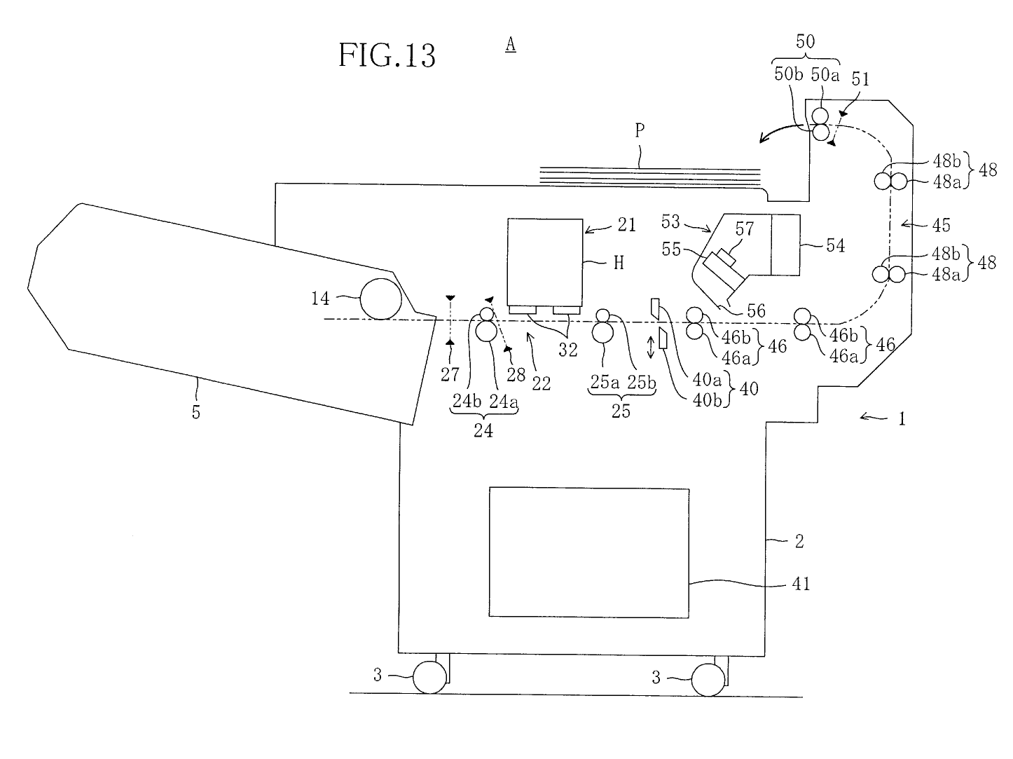

As shown in FIG. 2, by attaching the duplex printing unit 7 to the printer main body 1, duplex printing on both sides of a media sheet P is enabled, as will be described later. Binding a plurality of media sheets P having received duplex printing enables formation of a photographic album or a photographic book. On the other hand, for simplex printing on only one side of the media sheet P, that is, in the case where duplex printing is unnecessary, the duplex printing unit 7 is detached from the printer main body 1 usually (see FIG. 13). It is noted that, even when the duplex printing unit 7 is attached to the printer main body 1, simplex printing on a media sheet P can be performed.

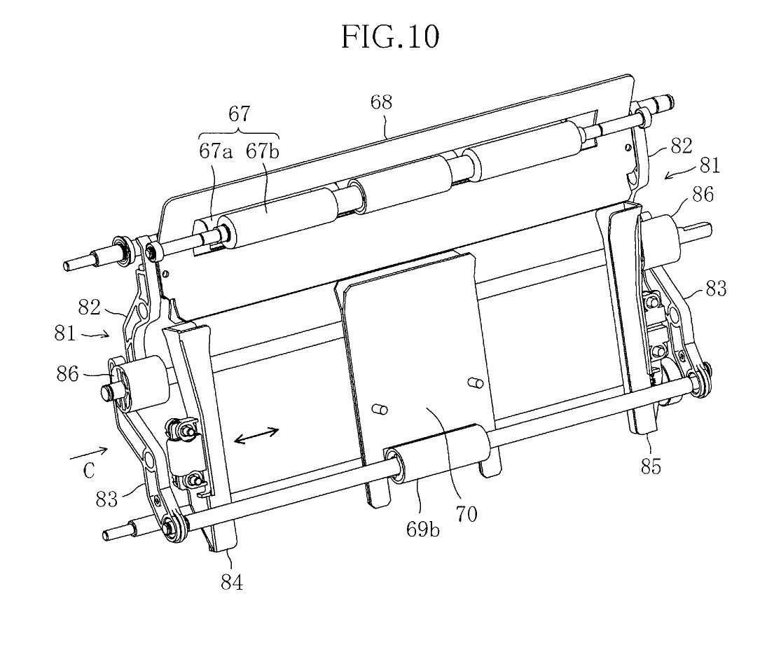

The cassettes 5 is exchanged according to the size of a media sheet P. The operator inputs through a manual switch (not shown) the size (length and width) of the media sheet P corresponding to the cassette 5 after the cassette 5 is attached to the printer main body 1. Further, the operator operates an operation member (not shown) to align width restricting members 84, 85 (see FIG. 10) of a correction mechanism 81, which will be described later, with the position corresponding to the width of the media sheet P. Alternatively, for example, an IC chip storing information indicating the size of a media sheet P and the like may be provided in the cassette 5 so that the printer main body 1 can read the stored information of the IC chip when the cassette 5 is attached thereto. This can eliminate the need for operator's input operation. Additionally, a motor may automatically perform alignment of the width restricting members 84, 85 of the correction mechanism 81 according to operator's input through the operation switch or the read information stored in the IC chip.

As shown in detail in FIG. 3, a set tray 11 for setting media sheets P stacked in their thickness direction is provided in the cassette 5. The set tray 11 is pivotally supported about an axis 11a extending in the printer transverse direction (right and left) at the approximate center in the printer longitudinal direction (back and forth) of the set tray 11 within the cassette 5. The set tray 11 receives spring force so as to turn in the direction that raises the printer rear side end of the set tray 11. This allows the uppermost media sheet P of a plurality of media sheets P set on the set tray 11 to come into contact with a feed roller 14 provided in the upper part of the printer rear side end in the cassette 5.

The feed roller 14 is driven and rotated in the anticlockwise direction in FIG. 3 by a motor (not shown) provided in the printer main body 1. When the motor drives and rotates the feed roller 14, only the uppermost media sheet P is moved toward the printer rear end to be fed outside the cassette 5. At this time, when the feed roller 14 is rotated by a predetermined amount, a tray pushdown mechanism 16 lowers the printer rear side end of the set tray 11 so that the uppermost media sheet P will not drag the media sheets P located under the uppermost media sheet P, and that a plurality of media sheets P are not simultaneously fed outside the cassette 5.

The tray pushdown mechanism 16 includes, within the printer main body 1, a tray pushdown lever 17 pivotally supported about an axis 17a extending in the printer transverse direction, and a lever pivot cam 18 for turning the tray pushdown lever 17 about the axis 17a. The lever pivot cam 18 is configured to turn about an axis 18a by a motor (not shown). Further, when the cassette 5 is attached to the printer main body 1, one end of the tray pushdown lever 17 enters to be located above the printer rear side end of the set tray 11 within the cassette 5. On the other hand, the other end of the tray pushdown lever 17 is in contact with the cam surface of the layer pivot cam 18. In order to always maintain this contact state, a spring pushes the tray pushdown lever 17 so that the other end moves toward the lever pivot cam 18, that is, so that the one end moves upward.

When the feed roller 14 is rotated by the predetermined amount, the lever pivot cam 18 rotates to cause the one end of the tray pushdown lever 17 to come into contact with and push down the printer rear side end of the set tray 11. This can prevent the uppermost media sheet P from dragging the media sheets P located under the uppermost media sheet P, thereby preventing a plurality of media sheets P from being simultaneously fed outside the cassette 5. It is noted that, when the lever pivot cam 18 makes a half turn, the one end of the tray pushdown lever 17 starts rising to cause the spring to raise the printer rear side end of the set tray 11, thereby allowing a media sheet P that will be the uppermost media sheet P next to come into contact with the feed roller 14. When the lever pivot cam 18 makes full turn, the lever pivot cam 18 stops rotating, and the tray pushdown lever 17 returns to the initial state.

The media sheet P fed outside the cassette 5 by the feed roller 14 is supplied to a printing section 21, which will be described later, in the printer main body 1. Therefore, the feed roller 14 of the cassette 5 corresponds to a media sheet supply section which supplies a media sheet P to the printing section 21.

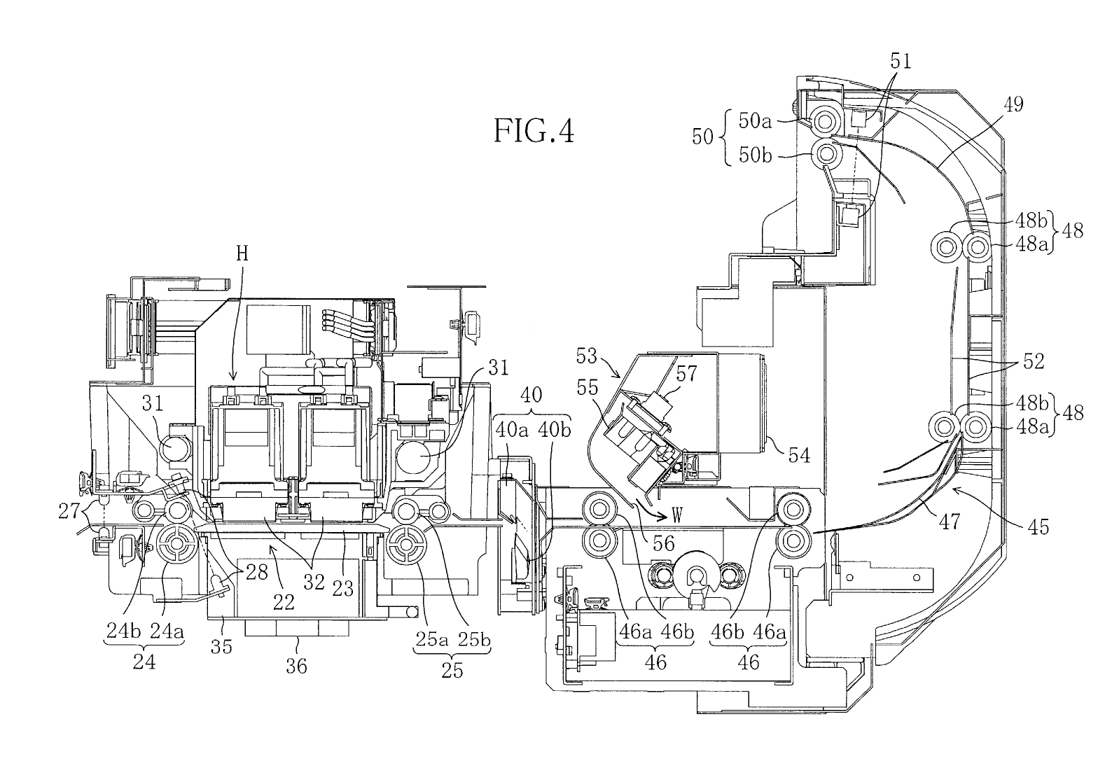

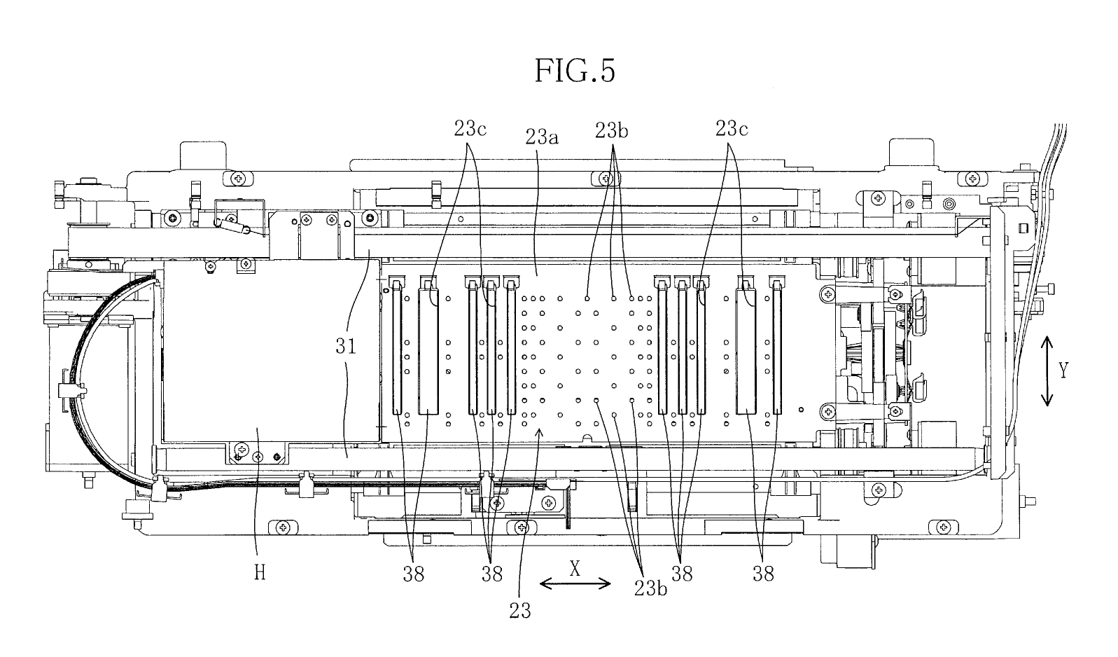

In the vicinity in the upper part of the housing 2 of the printer main body 1 where the cassette 5 is attached, the printing section 21 is provided which prints based on image data. The printing section 21 includes a print head H, a feeding section 22, and a platen 23, as show in detail in FIG. 4 and FIG. 5. The print head H prints on one side (upper side surface) of a media sheet P. The feeding section 22 substantially horizontally feeds the media sheet P supplied from the feed roller 14 to the side (the printer rear side) opposite to the side of the feed roller 14 in printing on the media sheet P. The platen 23 is opposed to the print head H, and supports the media sheet P fed by the feeding section 22.

There are disposed an upstream side roller pair 24 of press-fit type at the upstream side end (printer front side end) of the feeding section 22, and a downstream side roller pair 25 of press-fit type at the downstream side end (printer rear side end) of the feeding section 22. Lower drive rollers 24a, 25a of the upstream side roller pair 24 and the downstream side roller pair 25 are driven by the same motor (not shown). Upper driven rollers 24b, 25b of the upstream side roller pair 24 and the downstream side roller pair 25 are switched between a state where they are press-fit against the corresponding lower drive rollers 24a, 25a and a state the press-fit state is released.

On the upstream and downstream sides of the upstream roller pair 24, first and second sensors 27, 28, both of which include light projection portions and photodetectors, for detecting a media sheet P are provided with the upstream side roller pair 24 interposed. The first sensor 27 detects that the tip end of a media sheet P enters the housing 2 of the printer main body 1 from the cassette 5 or the duplex printing unit 7. Upon detection by the sensor 27, the drive roller 24a of the upstream side roller pair 24 is driven. The second sensor 28 detects the tip end of the media sheet P fed from the upstream side roller pair 24. When the upstream side roller pair 24 feeds, after detection of the tip end of the media sheet P by the second sensor 28, the media sheet P by an amount that allows a print start point of the media sheet P to reach a part below the print head H, printing on the media sheet P starts. Further, when the upstream side roller pair 24 feeds, after detection of the tip end of the media sheet P by the second sensor 28, the media sheet P by an amount that allows the tip end of the media sheet P to reach the downstream side roller pair 25, the press-fit state of the upstream side roller pair 24 is changed to the press-fit released state, and the press-fit released state of the downstream side roller pair 25 is changed to the press-fit state. Then, the downstream side roller pair 25 feeds the media sheet P.

The print head H is configured to move along two guide rails 31 extending in a main scan direction X (see FIG. 5) agreeing with the width direction of a media sheet P (the printer transverse direction) above the media sheet P. The print head H includes two head units 32 arranged side by side in a sub scan direction Y (see FIG. 5) agreeing with the direction in which the media sheet P moves (the printer longitudinal direction), which is perpendicular to the main scan direction X. By downwardly ejecting ink in a plurality of colors from multiple ink ejection nozzles (not shown) provided at the lower surface of the two head units 32, a predetermined image can be printed on the upper surface of the media sheet P. In the present example embodiment, the two head units 32 are provided side by side in the sub scan direction Y. However, the number of head units is not limited to two, and may be one or three or more.

The print head H is made of LCP (liquid crystal polymer) excellent in heat resistance for suppressing adverse influence of thermal expansion. The distance between the two head unites 32 provided as above may vary due to temperature rise to cause printing misalignment. The print head H is made of LCP for preventing this phenomenon.

The head units 32 have the same configuration, and include a plurality of nozzle arrays for ejecting ink in colors, which are arranged in the main scan direction X. In the nozzle arrays, the aforementioned ink ejection nozzles are arranged in the sub scan direction Y. Accordingly, each head unit 32 can form a color image solely. The upstream side roller pair 24 and the downstream side roller pair 25 feed a media sheet P in the sub scan direction Y intermittently (step by step) by a given unit feeding amount. At each stop of the media sheet P in this intermittent feed, the print head H performs one scan (one one-way operation or one return operation) in the main scan direction X. During such one scan, the ink is ejected from the ink ejection nozzles in colors of the head units 32 at respective points in the main scan direction X onto the upper surface of the media sheet P. That is, after one scan by the print head H, the media sheet P is fed by the unit feeding amount. Then, the print head H performs one scan again. The above operation is repeated to print a desired image.

Here, as a configuration for ink ejection of the print head H in the present example embodiment, a general piezoelectric configuration may be employed in which the volume in a pressure chamber in which the ink is filled is changed by a piezoelectric element to cause the ink to be ejected from the ink ejection nozzles communicating with the pressure chamber.

The platen 23 is formed with a plate-shaped member, and has an upper surface serving as a support surface 23a supporting a media sheet P. Multiple suction holes 23b (see FIG. 5) opening in the support surface 23a are formed through the platen 23 in the thickness direction (vertical direction). As shown in FIG. 4, a casing 35 forming a space together with the platen 23 is disposed below the platen 23. A suction device 36 including a fan and the like is disposed below the casing 35. The suction holes 23b communicates with the space in the casing 35. This space communicates with the suction port of the suction device 36. When the suction device 36 is operated, negative pressure is generated on the support surface 23a of the platen 23 through the suction holes 23b, thereby allowing a media sheet P to be sucked to and held on the support surface 23a of the platen 23. This can ensure flatness of the media sheet P at printing to increase printing quality.

Further, recesses 23c (see FIG. 5) extending in the sub scan direction Y are formed in the support surface 23a of the platen 23 for housing ink absorbers 38. Part of the ink ejected from the print head H (the head units 32) may go beyond and outside the edges in the width direction of a media sheet P on the support surface 23a in borderless printing where an image is printed on the entire media sheet P. The ink absorbers 38 are provided for preventing a smear on the support surface 23a of the platen 23 by the ink having gone outside. Accordingly, the recesses 23c are formed at positions in the support surface 23a corresponding to the edge in the width direction of a media sheet P on the support surface 23a and corresponding to the print head H in the sub scan direction Y so as to extend along the edge (i.e., extend in the sub scan direction Y) in the support surface 23a. In the example shown in FIG. 5, the recesses 23c are formed five by five (ten in total) on the respective sides so as to address media sheets P having five different widths. The ink absorbers 38 are preferably in, for example, a sponge form excellent in ink absorption.

Here, in borderless printing, the ink is ejected to the absolute edges in the width direction of a media sheet P, and the ink absorbers 38 absorb the ink having gone beyond and outside the edge. On the other hand, the ink is not ejected to the absolute front edge and the absolute rear edge of the media sheet P with a predetermined amount (e.g., 2 mm) left as margins. Then, the margins are cut off by a cutter 40, which will be described later, to obtain a borderless image. The reason for doing so is as follows. If the ink is ejected toward the front edge and the rear edge of the media sheet P, the ink beyond them may be sucked into the suction holes 23b by suction through the suction holes 23b to degrade printing quality, and may cause the support surface 23a to be smeared with the ink.

On the downstream side of the feeding section 22 in the upper part of the housing 2 of the printer main body 1, a U-turn section 45 is provide which causes a media sheet P fed from the downstream side end (the downstream side roller pair 25) of the feeding section 22 to make a U-turn so that the media sheet P is flipped over and its feed direction is reversed.

Between the U-turn section 45 and the feeding section 22, the cutter 40 is disposed. In borderless printing, the cutter 40 sequentially cuts the margins at the front edge part and the rear edge part of the media sheet P printed by the printing section 21 and substantially and horizontally fed from the feeding section 22. The cutter 40 includes a fixed blade 40a and a movable blade 40b. The fixed blade 40a is disposed so as to extend in the width direction of a media sheet P (the main scan direction X) on the upper side of the media sheet P feed path. The movable blade 40b is disposed so as to extend in the width direction of a media sheet P on the lower side of the media sheet P feed path, and is moved by a motor (not shown) vertically relative to the fixed cutter 40a. When a to-be-cut part of the media sheet P is positioned between the fixed blade 40a and the movable blade 40b, the movable blade 40b moves from bottom to top of the media sheet P, thereby cutting the media sheet P. Chips formed by such cutting fall down and are housed in a chip box 41 (see FIG. 2) disposed in the lower part of the housing 2. In the case of borderless printing on both sides of a media sheet P, the cutter 40 cuts the margins after printing on both sides thereof.

The U-turn section 45 includes two feed roller pairs 46 of press-fit type disposed on the upstream side of the U-turn section 45 and substantially horizontally feeding the media sheet P from the feeding section 22 further toward the printer rear side, a first direction changing member 47 (see FIG. 4) changing upward the feed direction of the media sheet P fed from the feed roller pairs 46, two feed roller pairs 48 of press-fit type disposed on the downstream side of the first direction changing member 47 and sandwiching and feeding upward the media sheet P, a second direction changing member 49 (see FIG. 4) changing the feed direction of the media sheet P fed from the feed roller pairs 48 toward the printer front side, a feed roller pair 50 of press-fit type disposed on the downstream side end of the U-turn section 45 and sandwiching the media sheet P and discharging it from the U-turn section 45, and a third sensor 51 (including a light projection portion and a photodetector) disposed in the vicinity of the feed roller pair 50 and detecting that the media sheet P is located at the position. Between the two feed roller pairs 48, a pair of guide plates 52 (see FIG. 4) are disposed so as to interpose the feed path. The guide plates 52 guides the tip end of the media sheet P sent from the lower feed roller pair 48 to the upper feed roller pair 48.

Between the two feed roller pairs 46 on the upstream side of the U-turn section 45, a dryer 53 that blows to the upper surface of the media sheet P dry wind W (see FIG. 4) for drying the ink adhering to the upper surface of a media sheet P in the printing section 21. The dryer 53 includes a suction fan 54 for taking air into the inside of the dryer 53, a heater 55 heating the air taken by the suction fan 54, an ejection nozzle section 56 opening to the lower end of the dryer 53 and blowing the air heated by the heater 55 as the dry wind W to the upper surface of the media sheet P, and a safety thermostat 57 detecting the temperature in the dryer 53 to urgently stop the heater 55.

In all the feed roller pairs 46, 48, 50 of the U-turn section 45, the rollers coming into contact with the surface opposite to the print surface of the media sheet P having received printing by the printing section 21 (lower rollers of the two feed roller pairs 46 on the upstream side, printer rear side rollers of the two feed roller pairs 48 on the downstream side of the feed roller pairs 46, and an upper roller of the feed roller pair 50) are drive rollers 46a, 48a, 50a. On the other hand, the rollers coming in contact with the print surface (upper rollers of the feed roller pairs 46, printer front side rollers of the feed roller pairs 48, and a lower roller of the feed roller pair 50) are driven rollers 46b, 48b, 50b. The driven rollers 46b, 48b, 50b are made of a material softer than the drive rollers 46a, 48a, 50a. For example, the drive rollers 46a, 48a, 50a are made of polypropylene, and the driven rollers 46b, 48b, 50b are made of urethane foam. When the driven rollers 46b, 48b, 50b coming into contact with the print surface are soft, the acceptable speed of the media sheet feed rate can be increased. Further, when the drive rollers 46a, 48a, 50a coming into contact with the surface opposite to the print surface are hard, accuracy of media sheet feed can be ensured. As a consequence, meandering and the like can hardly occurs.

All the drive rollers 46a, 48a, 50a are driven by the same motor (not shown). The rotational speed of the drive rollers 46a, 48a, 50a, that is, the media sheet feed rate by the feed roller pairs 46, 48, 50 is variable. The dryness of the ink by the dryer 53 varies depending on the environmental conditions (temperature, humidity, etc.) where the inkjet printer A is installed. Therefore, the feed rate is changed accordingly. Further, where the duplex printing unit 7 is attached to the printer main body 1, the ink is dried within the time when the duplex printing unit 7 feeds the media sheet P. Therefore, the feed rate is set at a comparatively high speed at which the ink may be incompletely dried by the dryer 53. By contrast, where the duplex printing unit 7 is not attached to the printer main body 1 (see FIG. 13), the media sheets P discharged from the U-turn section 45 by the feed roller pair 50 are directly discharged outside the body 2, and are placed and staked on the upper surface of the housing 2. Therefore, the feed rate is set at a comparatively low speed at which the ink can be completely dried by the dryer 53.

The third sensor 51 detects the rear end of a media sheet P for detecting discharge of the media sheet P from the U-turn section 45. Where the duplex printing unit 7 is not attached to the printer main body 1, the third sensor 51 detects discharge of a media sheet P from the housing 2. By contrast, where the duplex printing unit 7 is attached to the printer main body 1, when a media sheet P is fed by an amount that allows the rear end of a media sheet P to be apart from the feed roller pair 50 after detection of the rear end of the media sheet P, the media sheet P feed rate in the duplex printing unit 7 is changed (increased).

The duplex printing unit 7 has a two-part configuration of a first unit 8 covering the upper surface of the housing 2 and a second unit 9 located above the cassette 5. In the state where the duplex printing unit 7 is attached to the printer main body 1, only the first unit 8 can be detached from the housing 2. When the first unit 8 is detached, maintenance of the printing section 21 (especially, the print head H etc.) can be carried out through the maintenance opening (usually shut by a lid) formed in the upper surface of the housing 2. Accordingly, even after the duplex printing unit 7 is attached to the printer main body 1, maintenance of the printing section 21 can be carried out easily.

Within the first unit 8 of the duplex printing unit 7, a reverse feeding section 61 is provided which feeds the media sheet P sent out from the U-turn section 45 to the side of the cassette 5 (printer front side relative to the printing section 21) over the printing section 21. The reverse feeding section 61 includes three feed roller pairs 62 of press-fit type sandwiching a media sheet P and feeding it toward the printer front side, and a fourth sensor 63 (including a light projection portion and a photodetector) disposed at a position of the downstream side end (printer front side end of the first unit 8) of the reverse feeding section 61 and detecting that a media sheet P is located at the position.

The feed path in the reverse feeding section 61 is a straight path slightly inclined downward as it goes toward the printer front side. The reason that the inclination is provided is as follows. That is, the level of the feed roller pair 50 of the U-turn section 45 is needed to be high enough so that a sufficient number of media sheets P can be stacked on the upper surface of the housing 2 where the media sheets P are placed in the case where the duplex printing unit 7 is not attached to the printer main body 1. On the other hand, in a switchback section 66 in the second unit 9, which will be described later, it is preferable to reduce as far as possible the number of supply roller pairs 69, which will be described later, supplying a switched-back media sheet P to the upstream side end of the feeding section 22 with the relationship with the minimum length of the media sheet P taken into consideration. To do so, it is necessary to dispose the switchback section 66 at a level close to the feeding section 22. Therefore, the feed path in the reverse feeding section 61 which connects the U-turn section 45 to the switchback section 66 is inclined as above.

Of all the feed roller pairs 62 of the reverse feeding section 61, rollers (upper rollers) coming into contact with the surface of a media sheet P opposite to the print surface printed by the printing section 21 are drive rollers 62a. Rollers (lower rollers) coming into contact with the print surface are driven rollers 62b. Similarly to the feed roller pairs 46, 48, 50 of the U-turn section 45, the driven rollers 62b are made of a material softer than the drive rollers 62a.

All the drive rollers 62a are driven by the same motor (not shown). The rotational speed of the drive rollers 62a, that is, the media sheet feed rate by the feed roller pairs 62 is variable, similarly to the drive rollers 46a, 48a, 50a of the feed roller pairs 46, 48, 50 of the U-turn section 45. As described above, the feed rate is increased when a media sheet P is fed by an amount that allows the rear end of the media sheet P to be apart from the feed roller pair 50 after detection of the rear end of the media sheet P by the third sensor 51. Specifically, since the feed path of the U-turn section 45 is curved, the feed rate must be set at a speed at which a media sheet P can be fed stably without damaging the print surface. Further, in the state where the rear end of a media sheet P is located on the upstream side of the feed roller pair 50, the media sheet feed rate by the feed roller pairs 62 must be set at the same speed as the feed rate in the U-turn section 45. However, when the rear end of the media sheet P goes beyond the feed roller pair 50, the media sheet P is fed in the straight feed path to increase the acceptable speed. Thus, the feed rate is increased. It is noted that the feed rate is adjusted according to the status of the other media sheets P (the number and position of existing media sheets P) existing on the downstream side of the media sheet P for which the feed rate is to be increased.

In the second unit 9, the switchback section 66 is provided which switches back the media sheet P fed from the reverse feeding section 61 and supplies it from its rear end to the upstream side end of the feeding section 22. The switchback section 66 includes a switchback roller pair 67 of press-fit type, a pair of first guide members 68, a supply roller pair 69 of press-fit type, and a pair of second guide members 70. The switchback roller pair 67 includes a lower drive roller 67a and an upper driven roller 67b. The first guide members 68 are provided so as to interpose the feed path on the upstream side of the switchback roller pair 67, and guide the media sheet P fed from the reverse feeding section 61 to the switchback roller pair 67. The supply roller pair 69 supplies the switched-back media sheet P to the upstream side end of the feeding section 22. The second guide members 70 are provided so as to interpose the feed path between the switchback roller pair 67 and the supply roller pair 69, and guide the switched-back media sheet P to the supply roller pair 69.

The drive roller 67a of the switchback roller pair 67 is capable of rotating, by a motor (not shown) in forward direction for sandwiching a media sheet P in combination with the driven roller 67b and feeding it toward the printer front side, and in reverse direction for sandwiching the media sheet P in combination with the driven roller 67b and feeding it toward the printer rear side.

The switchback roller pair 67 and the first guide members 68 are integrally rotated by the motor (not shown) about the rotation axis of the drive roller 67a of the switchback roller pair 67. This enable the driven roller 67b of the switchback roller pair 67 to be switched between a first position (see FIG. 6) where it is located substantially right above the drive roller 67a and a second position (see FIG. 7) where it is located on the printer rear side of the drive roller 67a. The first guide members 68 are located on the extension of the feed path in the reverse feeding section 61 (see FIG. 6) when the driven roller 67b is at the first position, and are located on the extension of the second guide members 70 (see FIG. 7) when the driven roller 67b is at the second position.

Here, a method for switching back the media sheet P fed from the reverse feeding section 61 will be described. At the time when the switchback roller pair 67 receives the media sheet P fed from the reverse feeding section 61, the driven roller 67a is rotated in the forward direction, and the driven roller 67b is set at the first position. When the switchback roller pair 67 feeds the media sheet P toward the printer front side by an amount that allows the rear end of the media sheet P to be located at the first guide members 68 (see FIG. 6) after the fourth sensor 63 detects the rear end, the forward rotation of the drive roller 67a is stopped. At this time, at least the front end part of the media sheet P is located above a placement tray 74, which will be described later.

Subsequently, the switchback roller pair 67 and the first guide members 68 are turned in the clockwise direction in FIG. 6 to switch the driven roller 67b from the first position to the second position. This raises the front end part (printer front side) of the media sheet P to curve the media sheet P and allow it to come into contact with two auxiliary rollers 72 disposed above the switchback roller pair 67 on the printer front side (see FIG. 7).

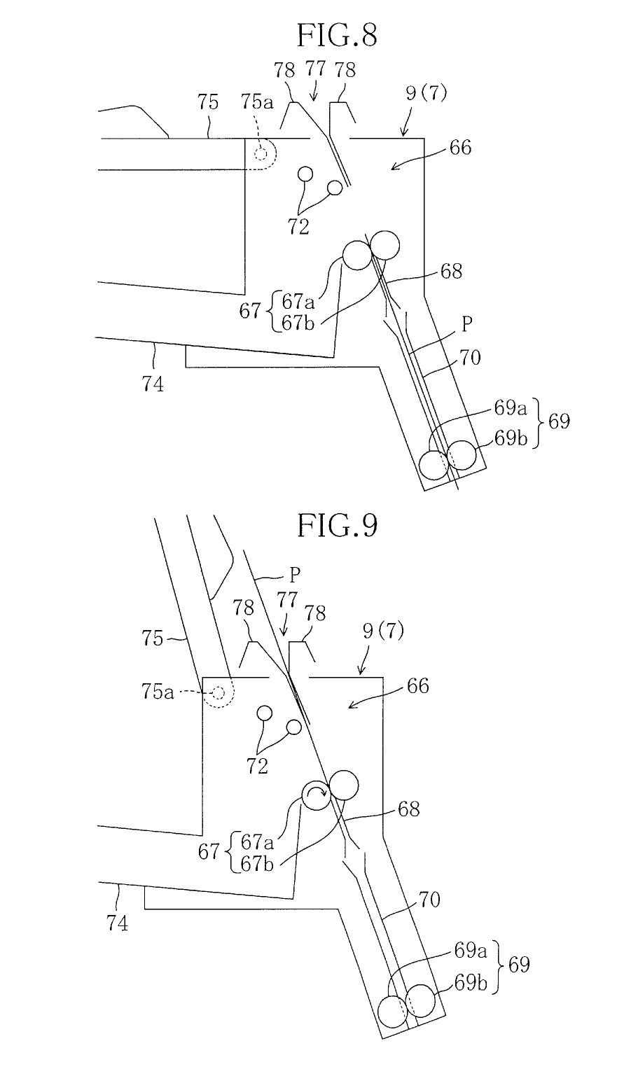

Thereafter, the drive roller 67a is rotated in the reverse direction to feed the media sheet P from its rear end to the supply roller pair 69. At this time, the auxiliary rollers 72 rotates accompanied by feed of the media sheet P. Therefore, the rear end part of the switched-back media sheet P (corresponding to the front end part in the forward rotation of the drive roller 67a) can be moved smoothly, and is not rubbed with the inner wall surface and the like of the second unit 9, thereby receiving no damage. The media sheet P switched back by the switchback roller pair 67 passes in the first guide members 68 and the second guide members 70 to reach the supply roller pair 69 (see FIG. 8).

The supply roller pair 69 includes a drive roller 69a driven by a motor (not shown) and a driven roller 69b press-fit against the drive roller 69a. The press-fit state of the driven roller 69b against the drive roller 69a can be released as will be described later. The same is applied to the driven roller 67b of the switchback roller pair 67.

Below the supply roller pair 69, a pair of third guide members 73 are disposed so as to interpose the feed path. A media sheet P is supplied through the third guide members 73 to the upstream side end of the feeding section 22. The upper surface of the media sheet P thus supplied to the feeding section 22 through the duplex printing unit 7 is the surface (hereinafter referred to as a reverse surface) opposite to the surface (hereinafter referred to as an obverse surface) of the media sheet P printed first by the printing section 21, and is not yet printed. Printing on the reverse surface similar to the first printing results in printing on both sides of the media sheet P.

The switchback roller pair 67 also serves for discharging the media sheet P fed by the reverse feeding section 61 outside the second unit 9 without switching it back. In other words, the switchback roller pair 67 continues to rotate the drive roller 67a in the forward direction without stop in the middle for discharging the media sheet P outside the second unit 9. The placement tray 74 which receives and places the media sheet P sent out from the switchback roller pair 67 is provided at the surface on the printer front side of the outer wall of the second unit 9. A media sheet P having received duplex printing as described above and/or a media sheet P having received simplex printing on only their obverse surfaces is/are discharged outside the second unit 9 by the switchback roller pair 67, and then are placed on the placement tray 74.

Above the placement tray 74, a covering member 75 for preventing dust and the like from adhering to the media sheet P placed on the placement tray 74 is supported at its one side on the surface on the printer front side of the outer wall of the second unit 9 so as to cover the placement tray 74. The covering member 75 is pivotally supported at its base end (printer rear side end) about an axis 75a (see FIGS. 6 to 9) extending in the printer transverse direction. Therefore, the covering member 75 can stand so as to extend upward from the base end by being turned about the axis 75a (see FIG. 9).

In the vicinity of the switchback roller pair 67, a manual paper feed opening 77 through which a media sheet P can be fed and inserted manually is formed in the upper surface of the outer wall of the second unit 9. At the manual paper feed opening 77, a pair of manual paper feed guide members 78 are disposed so as to interpose a manually fed and inserted media sheet P in the thickness direction. The manual paper feed guide members 78 guides the tip end of the manually fed and inserted media sheet P to the switchback roller pair 67. Further, the manual paper feed opening 77 is covered with a lid 79 (see FIG. 1). In order for the operator to feed and insert a media sheet P, the operator opens the lid 79, and operates a mode switch (not shown) to switch the switch mode to a manual feed mode. This switches the driven roller 67b of the switchback roller pair 67 to the second position, and causes the drive roller 67a to rotate in the reverse direction. Then, the operator inserts a media sheet P from the manual paper feed opening 77. At this time, if the covering member 75 stands, it can serve as a receiver for supporting the media sheet P, thereby facilitating insertion of the media sheet P. When the media sheet P is inserted from the manual paper feed opening 77 in this way, the media sheet P is fed by the switchback roller pair 67 to the supply roller pair 69, and then is supplied to the feeding section 22 (printing section 21) by the supply roller pair 69, similarly to the switched-back and fed media sheet P.

As shown in FIG. 10, the switchback section 66 includes a correction mechanism 81 which corrects the position in the width direction of the media sheet P supplied to the feeding section 22. The correction mechanism 81 includes, on the respective printer transverse sides of the second guide members 70, a pair of right and left upper release levers 82, a pair of right and left lower release levers 83, and a pair of right and left width restricting members 84, 85. The upper release levers 82 set the driven roller 67b of the switchback roller pair 67 to be in a press-fit released state. The lower release levers 83 set the driven roller 69b of the supply roller 69 to be in a press-fit released state. The width restricting members 84, 85 come into contact with respective side ends in the width direction of the media sheet P.

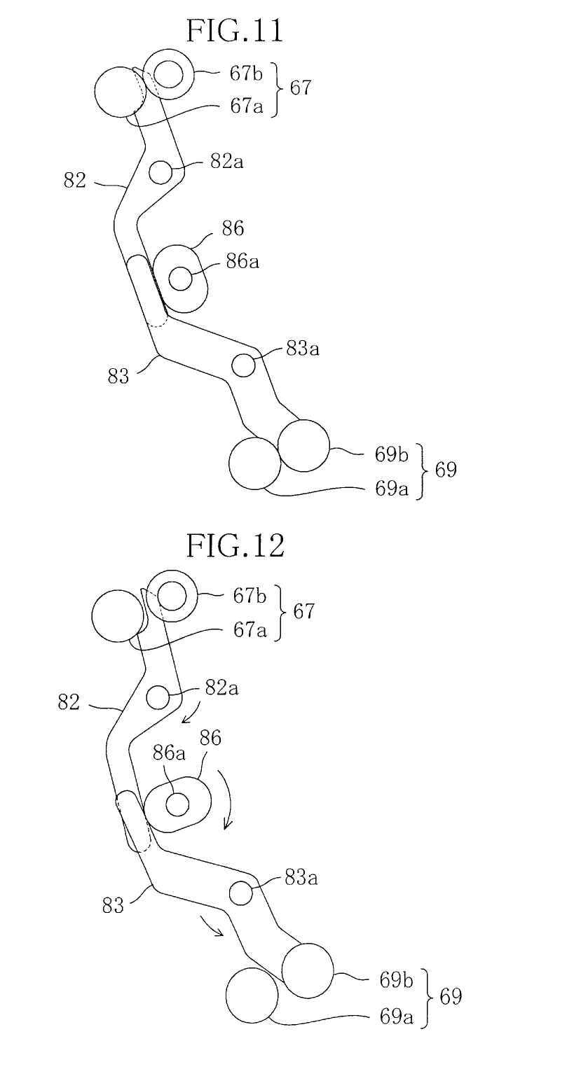

As shown in FIG. 11, the upper release levers 82 and the lower release levers 83 are pivotable about axes 82a, 83a extending in the printer transverse direction, respectively. One end of each upper release lever 82 is located in the vicinity of the axial end of the driven roller 67b in the press-fit state when the switchback roller 67 is set at the second position. The other end of each upper release lever 82 is in contact with the cam surface of a release cam 86 supported by an axis 86a extending in the printer transverse direction. One end of each lower release lever 83 is coupled to the axial end of the driven roller 69b of the supply roller pair 69. The other end of each lower release lever 83 is in contact with the cam surface of the release cam 86.

The release cam 86 is rotated by a motor (not shown) together with its axis 86a. As shown in FIG. 12, rotation of the release cam 86 by 90° turns the upper release levers 82 about the axis 82a in the clockwise direction in FIG. 12 to set the driven roller 67b of the switchback roller pair 67 to be in the press-fit released state, and turns the lower release levers 83 about the axis 83a in the anticlockwise direction in FIG. 12 to set the driven roller 69b of the supply roller pair 69 to be in the press-fit released state. Then, rotation of the release cam 86 further by 90° sets the driven rollers 67b, 69b of the switchback roller pair 67 and the supply roller pair 69 to be in the press-fit states. Accordingly, the upper release levers 82, the lower release levers 83, and the release cam 86 configure a switching mechanism for switching the switchback roller pair 67 and the supply roller pair 69 between the press-fit states and the press-fit released states.

The width restricting members 84, 85 are positioned by the operator's operation at positions corresponding to the width of a to-be-printed media sheet P, as described above. Specifically, the width restricting members 84, 85 are located at the positions where they come into contact with the side ends in the width direction of a to-be-printed media sheet P. The width restricting members 84, 85 are bent so as to form rectangular grooves opening toward the surfaces opposed to each other. The bottoms of the grooves come into contact with the side ends in the width direction of a media sheet P. It is noted that the upstream side parts of the bottoms of the grooves are inclined outward in the width direction of the feed path as they go upstream so as to guide a media sheet P into the grooves.

One 84 (left hand in FIG. 10) of the width restricting members 84, 85 is configured to move in the width direction of a media sheet P by a predetermined amount with a distance left from the position positioned by the operator's operation, and receives spring force so as to approach the other width restricting member 85 (right hand in FIG. 10). The width restricting member 85 is fixed at a position positioned by the operator's operation. The spring force of the width restricting member 84 pushes a media sheet P toward the width restricting member 85 to allow the end of the media sheet P on the side of the width restricting member 85 to come in contact with the width restricting member 85. The width restricting member 85 is disposed so that the position of the media sheet P at this time is a reference position in the width direction of the feed path.

However, the spring force of the width restricting member 84 is comparatively small. Accordingly, during the time when the switchback roller pair 67 or the switchback roller pair 67 and the supply roller pair 69 feed(s) a media sheet P, the feeding force of the roller pairs 67, 69 overpowers the spring force of the width restricting member 84. Therefore, the width restricting member 84 cannot push the media sheet P toward the width restricting member 85. In other words, the spring force of the width restricting member 84 is set at a value at which a media sheet P can be moved in its width direction when the switching mechanism switches the driven rollers 67b, 69b of the switch back roller pair 67 and the supply roller pair 69 to the press-fit released state. For this reason, during feed of a media sheet P, the width restricting member 84 cannot correct the position in the width direction of the media sheet P, and moves in the width direction of the media sheet P in association with meandering of the media sheet P. As a result, the media sheet P tends to be displaced left in FIG. 10 from the reference position.

In view of this, the correction mechanism 81 switches the driven rollers 67b, 69b of the switchback roller pair 67 and the supply roller pair 69 to the press-fit released states to move a media sheet P toward the width restricting member 85 by the spring force of the width restricting member 84, thereby correcting the position in the width direction of the media sheet P relative to the feed path. Specifically, when the tip end of a media sheet P reaches a predetermined point (e.g., slightly downstream side of the supply roller pair 69), feed of the media sheet P by the switchback roller pair 67 and the supply roller pair 69 stops. Then, the switching mechanism sets the driven rollers 67b, 69b of the switchback roller pair 67 and the supply roller pair 69 to the press-fit released states. This makes the media sheet P free to move the media sheet P toward the width restricting member 85 by the spring force of the width restricting member 84, thereby accurately aligning the media sheet P to the reference position in the width direction of the feed path. Thus, the position in the width direction of the media sheet P relative to the feed path can be corrected. Also, the posture (inclination) of the media sheet P relative to the feed path can be corrected to the proper posture. After a predetermined period (a period until correction by moving the media sheet P by the spring force of the width restricting member 84 completes) elapses from the time when the press-fit released state is set, the switching mechanism sets the driven rollers 67b, 69b of the switchback roller pair 67 and the supply roller pair 69 to the press-fit states. Then, the switchback roller pair 67 and the supply roller pair 69 start feeding the media sheet P.

The above described correction is performed once or plural times on the same media sheet P. In the case where it is performed plural times, when a media sheet P is fed by a predetermined amount from feed restart, the feed is stopped again to repeat the same correction as above. The number of times of correction performed is determined according to the characteristics of a media sheet P (dimensional characteristics, such as length, thickness, etc., material characteristics, such as hardness, surface quality (glossy and matte), etc.). For example, as the length of a media sheet P (determined by the information on size of the media sheet P input by the operators, as described above) increases, the number of times of correction is increased, thereby correcting the position in the width direction of the media sheet P over its entire length. Further, if a media sheet P is hard to be moved in the width direction depending on the thickness, hardness, and the like of the media sheet P (of which information is input by the operator, or stored in and read from an IC chip provided in the cassette 5, as described above), the number of times of correction is increased accordingly. It is preferable to change the positions where a media sheet P is stepped for correction (i.e., the aforementioned predetermined position and predetermined amount) according to the number of times of correction.

Rather than by the spring force of the width restricting member 84, the width restricting member 84 may be moved by, for example, an actuator (a driving device, such as a motor) and a movement limiting device (a torque limiter etc.). Alternatively, both the width restricting members 84, 85 may be moved by a force applying member, such as a spring, or by an actuator and a movement limiting device.

Thus, a media sheet P is supplied to the feeding section 22 (printing section 21) with it accurately aligned to the reference position in the width direction of the feed path to allow the printing section 21 to stably print at the appropriate position on a media sheet P, thereby improving printing quality.

The U-turn section 45, the reverse feeding section 61, and the switchback section 66 configure a media sheet re-supply section 88 which connects the downstream side end to the upstream side end of the feeding section 22 to form an orbit feed path surrounding the print head H together with the feeding section 22, and which flips over the media sheet P sent out from the downstream side end of the feeding section 22 whose obverse surface has received printing, and supplies it to the upstream side end of the feeding section 22. By the media sheet re-supply section 88, a media sheet P whose obverse surface has received printing can be flipped over and supplied again to the printing section 21. Printing on the reverse surface of this media sheet P results in printing on both sides of the media sheet P.

The U-turn section 45 and the reverse feeding section 61 feed to the switchback section 66 the media sheet P whose reverse surface has received printing, similarly to the feed after the obverse surface of the media sheet P receives printing (first feed of the media sheet P). At this time, the switchback roller pair 67 of the switchback section 66 continues to rotate in the forward direction, thereby discharging the media sheet P onto the placement tray 74. It is noted that, when the U-turn section 45 and the reverse feeding section 61 feed the media sheet P whose reverse surface has received printing, the drive rollers 46a, 48a, 50a, 62a of the feed rollers 46, 48, 50, 62 come into contact with the obverse surface of the media sheet P. However, since the ink adhering to the obverse surface is completely dried at this time point, the media sheet P can be fed at the same feed rate as that at the first feed. Nevertheless, the feed rate at the second feed may be set lower than that of the first feed for further increasing printing quality.

The length of the feed path of the media sheet re-supply section 88 is set to be capable of holding, during printing on a current media sheet P by the printing section 21, at least one preceding media sheet P having received printing prior to the current media sheet P. Accordingly, the time between printing on the obverse surface of one media sheet P and printing on its reverse surface can be utilized for printing on at least one successive media sheet P.

For example, in the case of duplex printing on the smallest media sheet P of those in the plural types of sizes, first to fourth media sheets P are supplied in series from the cassette 5 to the printing section 21, and the printing section 21 successively prints on their obverse surfaces. When the fourth media sheet P is being printed, the three media sheets P having received printing are located at any parts of the media sheet re-supply section 88 (usually, the first media sheet P, the second media sheet P, and the third media sheet P are located at the switchback section 66, the reverse feeding section 61, and the U-turn section 45, respectively). When printing on the fourth media sheet P terminates, the first media sheet P whose obverse surface has received printing is supplied to the printing section 21 next for printing on the reverse surface of the first media sheet P. Subsequently, the reverse surfaces of the second to fourth media sheets P are successively printed. When the reverse surface of the fourth media sheet P is being printed, the first media sheet P is discharged onto the placement tray 74 by the switchback roller pair 67, and the second and the third media sheets P are located at the reverse feeding section 61 and the U-turn section 45, respectively.

When printing on the fourth media sheet P terminates, fifth to eighth media sheets P are supplied in series from the cassette 5 to the printing section 21 next. Then, the printing section 21 successively prints on the obverse surfaces of the media sheets P. Thus, the obverse surfaces and the reverse surfaces of sets of four media sheets P are sequentially printed. It is noted that a set of media sheets P for simplex printing can be interposed between two sets for duplex printing.

Thus, in the present example embodiment, in the case of duplex printing on only one media sheet P, the reverse surface of the media sheet P is printed after the media sheet P whose obverse surface has received printing passes through the long feed path of the media sheet re-supply section 88, thereby lengthening the processing time. By contrast, in the case of duplex printing on a predetermined number or more of media sheets P for business purpose or the like, the media sheet re-supply section 88 enables printing on another media sheet P during feed of at least one media sheet P, thereby increasing printing capacity. Further, the ink adhering to the obverse surface of a media sheet P in the printing section 21 can be sufficiently dried during the time until the reverse surface is printed. Printing on the reverse surface in such a dried state prevents both sides of the media sheet P from being simultaneously wet by the ink, thereby ensuring prevention of strike through and the like caused by ink penetration. In addition, media sheets P are hard to be curled and waved, thereby preventing degradation of printing quality of media sheets P.

What is claimed is:

1. An inkjet printer including a printing section which prints on one side of a media sheet by ejecting ink from a print head, a media sheet supply section which supplies the media sheet to the printing section, and a feeding section which is provided at the printing section, and which feeds the media sheet supplied from the media sheet supply section to a side opposite to a side of the media sheet supply section when the media sheet is being printed, where the media sheet one of sides of which has received printing in the printing section is flipped over and is supplied again to the printing section, and the printing section prints on another side of the media sheet, thereby printing both sides of the media sheet, the inkjet printer comprising:
a media sheet re-supply section which connects a downstream side end to an upstream side end of the feeding section to form an orbiting feed path together with the feeding section, and which flips over the media sheet sent out from the downstream side end of the feeding section, of which the one side has received printing, and supplies it to the upstream side end of the feeding section, wherein
the media sheet re-supply section includes
a U-turn section which causes the media sheet sent out from the downstream side end of the feeding section to make a U-turn so as to flip over the media sheet and change a feed direction of the media sheet to a reverse direction,
a reverse feeding section which feeds the media sheet sent out from the U-turn section to a side of the media sheet supply section over the printing section, and
a switchback section which switches back the media sheet fed from the reverse feeding section, and supplies it from its rear end to the upstream side end of the feeding section, and
the media sheet re-supply section has a length of a feed path capable of holding, during printing on a current media sheet by the printing section, at least one preceding media sheet printed prior to the current media sheet.

2. The inkjet printer of claim 1, wherein
the switchback section includes a correction mechanism which corrects a position in a width direction of the media sheet supplied to the upstream side end of the feeding section.

3. The inkjet printer of claim 1, wherein
a feed rate of the media sheet is variable in the U-turn section and the reverse feeding section.

4. The inkjet printer of claim 1, wherein
the U-turn section and the reverse feeding section include feed roller pairs for sandwiching and feeding the media sheet, and
of the feed roller pairs, rollers coming into contact with the one side of the media sheet, which has received printing, are made of a material softer than rollers coming into contact with the other side thereof.
